(19) United States
(12) Patent Application Publication
(10) Pub. No.: US 2015/0269596 A1
(43) Pub. Date: Sep. 24, 2015

(54) SYSTEMS AND METHODS FOR ASSESSING CUSTOMER CENTRIC BUSINESS PROCESS METHOD MATURITY

(71) Applicants: Ritesh Kumar JAIN, Ngalore (IN); Sachin Khaitan, Bangalore (IN)

(72) Inventors: Ritesh Kumar JAIN, Ngalore (IN); Sachin Khaitan, Bangalore (IN)

(73) Assignee: WIPRO Limited, Bangalore (IN)

(21) Appl. No.: 14/268,237

(22) Filed: May 2, 2014

(30) Foreign Application Priority Data
Mar. 20, 2014 (IN) 1460/CHE/2014

(51) Int. Cl. G06Q 30/02

(52) U.S. Cl. CPC G06Q 30/0203

(57) ABSTRACT

The present disclosure relates to methods of systems for assessing customer centric BPM maturity of an organization. Embodiments of the present disclosure may create an assessment model for an initiative, wherein creating the assessment model includes providing an initial assessment criteria selection for presentation on a user device. Create the assessment model may also include receiving, from the user device, a selection of initial assessment criteria and calculating a first score based on the selected assessment criteria. Create the assessment model may also include determining a first maturity state of the initiative based on the first score, and generating a first plurality of guidelines associated with the first score for moving the initiative to a maturity state that is not the first maturity state.

### PRIORITY CLAIM

This U.S. patent application claims priority under 35 U.S.C. §119 to: Indian Patent Application No. 1460/CHE/2014, filed Mar. 20, 2014. The aforementioned applications are incorporated herein by reference in their entirety.

### TECHNICAL FIELD

This disclosure relates generally to tracking a business process management (BPM) initiative. More specifically, it is related to assessing the implementation of a BPM initiative in view of customer feedback.

### BACKGROUND

BPM is known as a complete management approach which positions a business' processes to fulfill a client's needs. BPM focuses on process automation and optimization using systematic methods to continuously improve the effectiveness and efficiency of business processes while focusing on innovation, adaptability, and technology integration. In a sense, BPM can give businesses the agility to adapt to more dynamic conditions in markets and the wherewithal to withstand significant management stressors.

However, currently BPM initiatives lack a feedback mechanism to assess their implementation. In essence, once a BPM initiative is established, it progresses without alteration based on feedback. Thus, customer acceptability and changing client needs are not taken into account when implementing a BPM initiative. Customer feedback is not measured with other key criteria of a BPM initiative, making it difficult to understand customer impact on a BPM initiative.

### SUMMARY

Certain embodiments of the present disclosure relate to a computer-implemented method for assessing customer centric BPM maturity of an organization, comprising creating, by at least one processor, an assessment model for an initiative, wherein creating the assessment model may include providing an initial assessment criteria selection for presentation on a user device. Creating the assessment model may also include receiving, from the user device, a selection of initial assessment criteria, calculating a first score based on the selected assessment criteria and determining a first maturity state of the initiative based on the first score. Creating the assessment model may also include generating a first plurality of guidelines associated with the first score for moving the initiative to a maturity state that is not the first maturity state.

In certain embodiments, the method may further comprise updating the assessment model by creating a new entry in the assessment model, wherein creating the new entry may include providing, for presentation on the user device, updated assessment criteria based on the first score. Creating the new entry may also include receiving, from the user device, a selection of updated assessment criteria and calculating an updated score based on the updated selected assessment criteria. Creating the new entry may also include determining an updated maturity state of the initiative, and generating an updated plurality of guidelines associated with the updated score for moving the initiative to a maturity state that is not the first maturity state or updated maturity state.

Certain embodiments of the present disclosure also relate to a non-transitory, computer-readable medium storing instructions that, when executed by a processor, cause the processor to perform operations comprising creating an assessment model for an initiative, wherein creating the assessment model may include providing an initial assessment criteria selection for presentation on a user device. Creating the assessment model may further include receiving, from the user device, a selection of initial assessment criteria and calculating a first score based on the selected assessment criteria. Creating the assessment model may further include determining a first maturity state of the initiative based on the first score, and generating a first plurality of guidelines associated with the first score for moving the initiative to a maturity state that is not the first maturity state.

In certain embodiments the instructions may perform further operations comprising updating the assessment model by creating a new entry in the assessment model, wherein creating the new entry may include providing, for presentation on the user device, updated assessment criteria based on the first score. Updating the assessment model may further include receiving, from the user device, a selection of updated assessment criteria, and calculating an updated score based on the updated selected assessment criteria. Updating the assessment model may further include determining an updated maturity state of the initiative, and generating an updated plurality of guidelines associated with the updated score for moving the initiative to a maturity state that is not the first maturity state or updated maturity state.

Certain embodiments of the present disclosure also relate to a system for assessing customer centric BPM maturity of an organization, comprising one or more hardware processors and a memory storing instructions that, when executed by the one or more hardware processors, cause the one or more hardware processors to perform operations. The operations may comprise creating an assessment model for an initiative, wherein creating the assessment model may include providing an initial assessment criteria selection for presentation on a user device and receiving, from the user device, a selection of initial assessment criteria. Creating the assessment model may also include calculating a first score based on the selected assessment criteria, determining a first maturity state of the initiative based on the first score, and generating a first plurality of guidelines associated with the first score for moving the initiative to a maturity state that is not the first maturity state.

In certain embodiments, the operations may further comprise updating the assessment model by creating a new entry in the assessment model, wherein creating the new entry may include providing, for presentation on the user device, updated assessment criteria based on the first score. Creating the new entry may also include receiving, from the user device, a selection of updated assessment criteria and calculating an updated score based on the updated selected assessment criteria. Creating the new entry may also include determining an updated maturity state of the initiative, and generating an updated plurality of guidelines associated with the updated score for moving the initiative to a maturity state that is not the first maturity state or updated maturity state.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 illustrates an exemplary customer-centric BPM system, according to some embodiments of the present disclosure.

FIG. 2 is a flowchart of an exemplary method for assessing customer-centric BPM maturity, consistent with the some embodiments of the present disclosure.

FIG. 3 is a table of exemplary BPM maturity states and customer centricity categories, according to some embodiments of the present disclosure.

FIG. 4 illustrates an exemplary table relating BPM maturity states with customer centricity categories, according to some embodiments of the present disclosure.

FIG. 5 is a table of exemplary questions and customer-centric BPM maturity scoring, according to an embodiment of the present disclosure.

FIG. 6 illustrates an exemplary functional block diagram of an administrative module, according to some embodiments of the present disclosure.

FIG. 7 illustrates an exemplary functional block diagram of an assessment module, according to some embodiments of the present disclosure.

FIG. 8 illustrates an exemplary functional block diagram of a reporting and analytics module, according to some embodiments of the present disclosure.

FIG. 9 illustrates an exemplary functional block diagram of an eLearning module, according to some embodiments of the present disclosure.

FIG. 10 illustrates an exemplary computer system for implementing methods and systems consistent with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

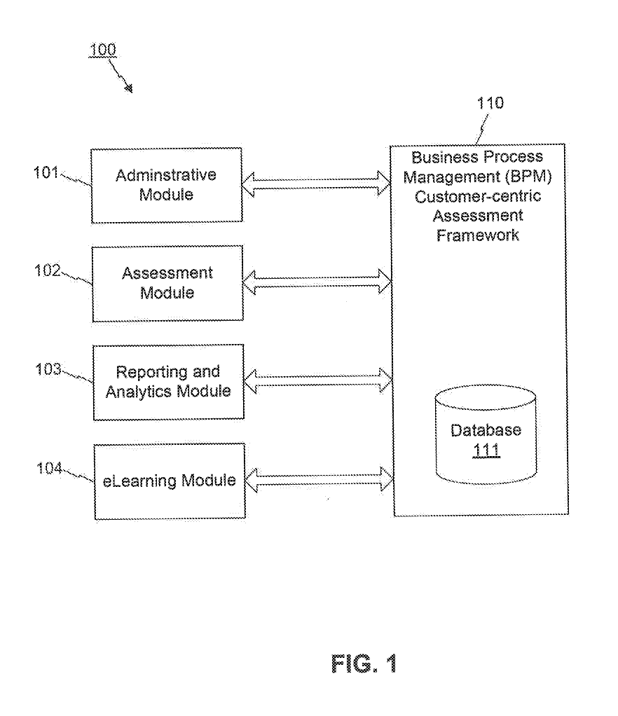

FIG. 1 illustrates an exemplary customer-centric BPM system 100, which may include BPM customer-centric assessment framework 110. BPM customer-centric assessment framework 110 may interact with various modules to fulfill the objects of this disclosure. BPM customer-centric assessment framework 110 may include database 111, which may store information to carry out the objects of this disclosure. Database 111 may be collocated with BPM customer-centric assessment framework 110 or may be located remotely, being connected by a computer network, such as the Internet.

In an exemplary embodiment, BPM customer-centric assessment framework 110 may be operably connected to, and may interact with, administrative module 101, assessment module 102, reporting and analytics module 103, and eLearning module 104. Each of these modules may be a discrete hardware element, such as an application-specific integrated circuit (ASIC), for example. In other embodiments, the modules may be software which operates on a computing device or a combination of hardware and software. Further, BPM customer-centric assessment framework 110 may be a discrete hardware element, such as a rack server, for example. In other embodiments, BPM customer-centric assessment framework may be software or a software architecture operable to run on a server or virtual machine. Each of the modules may retrieve and store data from database 111.

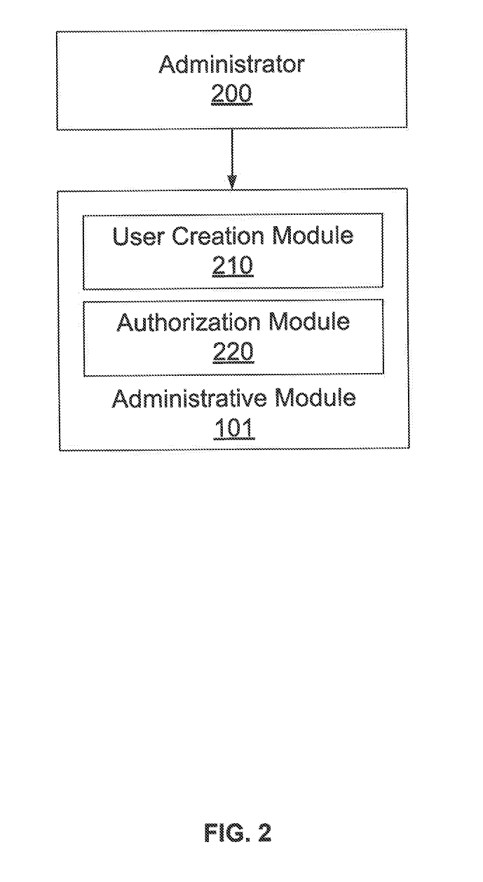

FIG. 2 illustrates an exemplary functional block diagram of administrative module 101, which may manage the authentication and authorization of all users of BPM customer-centric assessment framework 110. Administrative module 101 may include user creation module 210 and authorization module 220. User creation module 210 may create user profiles, which may include a username and password, in addition to other data for identifying a user. For example, user creation module 210 may label a user as being a part of a specific organization, a department within the organization, and a specific role within the department. Additionally, a user may be identified by seniority (e.g., number of years of experience) or placement in the management hierarchy (e.g., manager, vice president, etc.). A seniority or placement level may be tied to a particular department or company. A user may be identified with multiple companies, departments, roles, seniority, and placement. For example, a user may be a manager of two departments, having spent 12 years with one department and three years with the other.

Exemplary user types may include an administrator, a process owner, and a manager. An administrator may be created as part of a solution implementation. In some embodiments, there may be only one administrator. A process owner may be the actual consumer of the solution. The process owner may be responsible for BPM initiatives in their department and would login to the assessment solution for evaluating their processes. They may have access only to the BPM processes created by them and may be able to perform multiple iterations of an evaluations exercise based on customer centricity improvement they have achieved on their BPM processes. A manager may be a management user who may primarily be looking at creating analytics, generating reports, and performing cross-department comparisons to ensure uniformity. A manager may be concerned with defining an organization's goals and ascribing objectives for improving customer centricity.

Authorization module 220 of administrative module 101 may provide authorization for a user to access certain portions of the framework. This may be for security or confidentiality purposes, such as sensitive projects with a need-to-know policy. The permissions assigned by authorization module 220 may also be assigned for organizational purposes, which may further permit users to focus only on portions of a BPM initiative that are relevant to their department or role in an organization. For example, some initiatives may encompass thousands of components spread across multiple companies with a total number of departments reaching the hundreds. In order to focus a particular user only on relevant tasks, authorization module 220 may only allow a user to see the tasks relevant to the department for which the user works. Other authorization needs may arise, which may be met using additional authorization schemes which may be known in the art.

Administrator 200 may be a person or a process and may interact with user creation module 210 and authorization module 220 to create users and manage authorizations. For example, administrator 200 may operate based on a predetermined schedule, automated responses, or human user input. Each organization may have a single implementation of BPM customer-centric assessment framework 110, including a single administrative module 101. In such an embodiment, all divisions would rely on the same administrative module 101. For example, administrator 200 may receive requests from various departments regarding the creation of a user. The request may include explicit authorization or authorization module 220 may determine permissions based on a user's name or another aspect of their profile, such as a department, for example. Administrative module 101 may then create the user based on the request. The request may come individually or in a batch. Also, verification of a user prior to user creation may be used to enhance security and avoid bugs or redundant users.

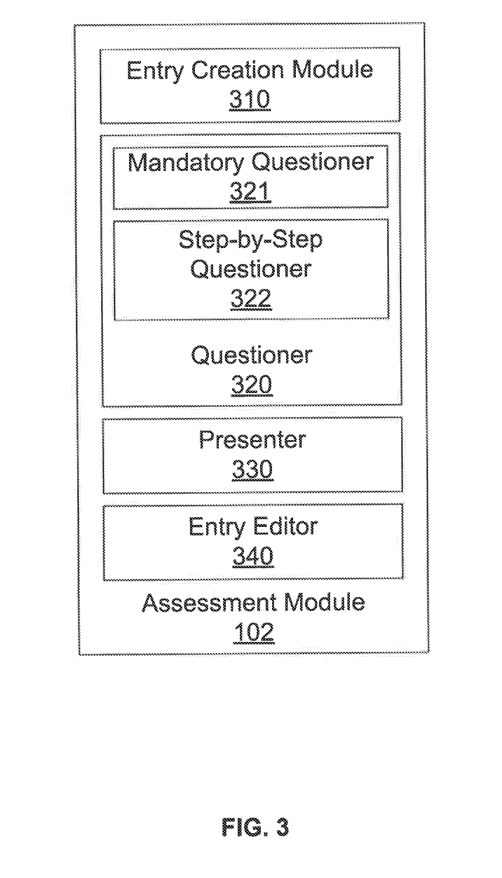

FIG. 3 illustrates an exemplary functional block diagram of assessment module 102, which may include entry creation module 310, questioner 320, presenter 330, and entry editor 340. After a user has access to an initiative, the user may use entry creation module 310 to create an entry for the BPM initiative the user is undertaking. This may be done preemptively, in which case the initiative may not be implemented yet.

Questioner 320 may then provide the user with required questions via mandatory questioner 321. Questioner 320 may also include step-by-step questioner 322, which may provide additional questions. For example, step-by-step questioner 322 may include questions based on the answers provided to mandatory questioner 321 to clarify answers or generate additional insight.

Once Questioner 320 is satisfied, presenter 330 may present an overview of all the answers provided to questioner 320, along with a result derived from BPM customer-centric assessment framework 110. A user may be able to print, download, or electronically transmit the overview. A user's ability to perform certain export functions may be based on user permissions provided by authorization module 220.

Further, assessment module 102 may include entry editor 340, which may allow a user to open a past entry in questioner 320 and recomplete all or part of the questions. Entry editor 340 may allow a user to selectively edit certain questions' responses. A user's ability to edit question responses may be restricted by a user's profile permissions. Such permissions may only allow a user to create a single entry or complete multiple entries for various BPM initiatives that may need an assessment. The ability to view an assessment may have permissions independent of the ability to answer questions or edit previous questions.

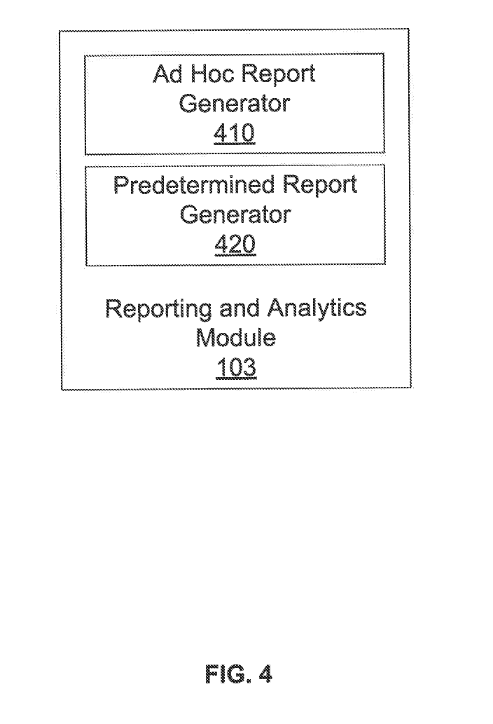

FIG. 4 illustrates an exemplary functional block diagram of reporting and analytics module 103, which may include ad hoc report generator 410 and predetermined report generator 420. Predetermined report generator 420 may generate reports of a predetermined type on a fixed schedule. Predetermined report generator 420 may also generate reports in response to predetermined criteria or based on a particular event, or both in combination. Ad hoc report generator 410 may be used to generate reports as needed.

For example, reporting and analytics module 103 may be used by managers or senior-level staff in an organization, allowing management to generate reports on BPM assessment which are undertaken by various departments. Additional report types may include organization-wide reports or comparative reports between departments. A monthly report may be made by predetermined report generator 420, which may identify a discrepancy between two departments, which may cause management to run a follow-up report a week later using ad hoc report generator 410.

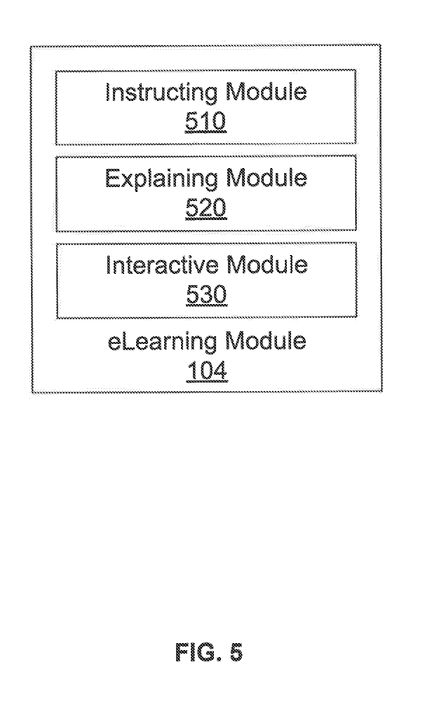

FIG. 5 illustrates an exemplary functional block diagram of eLearning module 104, which may include instructing module 510, explaining module 520, and interactive module 530. Each of these modules may allow a user to learn about different aspects of BPM customer-centric assessment framework 110. This may allow a company to reduce or eliminate application support or introductory training.

Instructing module 510 may help the user understand how to use BPM customer-centric assessment framework 110. Instructing module 510 may include step-by-step descriptions with pictorial diagrams, which describe how to create an assessment using assessment module 102 or generate reports using reporting and analytics module 103. Movies, animations, and interactive exercises may be used to optimize results. Explaining module 520 may explain how to read the result of an assessment and describe the inferences one can make from the marks. Explaining module 520 may use examples of other successful guidelines to aid a user's understanding. Interactive module 530 may include collaborative features. The features may permit a user to ask questions to another user or database, dialogue with an administrator, and post best practices for other users to read and comment on.

Administrative module 101, assessment module 102, reporting and analytics module 103, and eLearning module 104 may operate independently or they may include interdependencies. For example, reporting and analytics module 103 may automatically link to eLearning module 104 when generating a report with a new variable or result which a user has not been presented with.

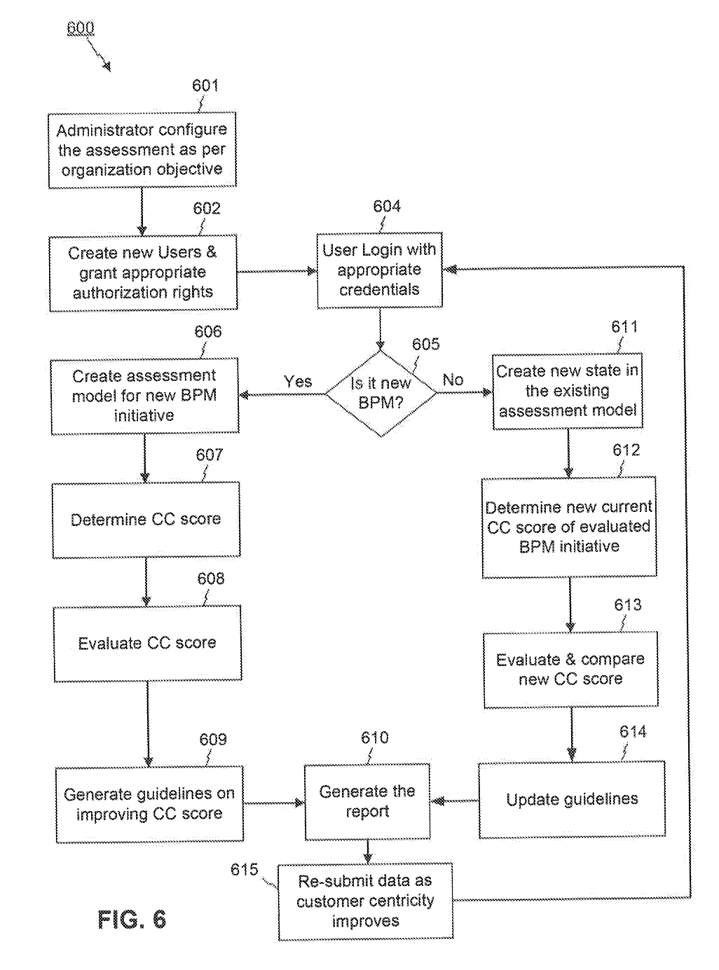

FIG. 6 is a flowchart of an exemplary method 600 for assessing customer-centric BPM maturity. Method 600 may begin with step 601, at which configuration parameters for the assessment may be received from an administrator based on the organization's objectives. Every organization may have different needs and objectives that may determine the customer centricity score. For example, in retail banking it may be very important to have a very high level of customer-centric processes with every process involving interactions with the customer in some manner. By contrast, utility industries, such as oil and gas, may not have as high a level of customer centricity because only a small portion of their operations involve customer interactions. Thus, at step 601, an administrator may take into account the level of customer interaction required by the organization in configuring the goals and objectives of the organization. Administrative module 101 may be used to set these criteria.

Next, at step 602, user creation and authorization requests may be received from an administrator. Users may be created using administrative module 101, as discussed above. Further the user types may be administrator, process owner, and manager, as discussed above.

At step, 604, the user may be able to login using the credentials set forth in step 602. Once a user has access, they may make use of eLearning module 104 to learn about the various procedures and tools. At step 605, the user may enter the BPM initiative, which may be identified by a label, formal name, or identification code. When the BPM initiative is new, method 600 may proceed to step 606.

At step 606, additional details surrounding the BPM initiative, such as associated process and dependencies, may be ascribed to the new BPM initiative. Additionally an assessment model for the BPM initiative may be created. At this step, a process owner may go through multiple questions, which may be provided by questioner 320 of assessment module 102.

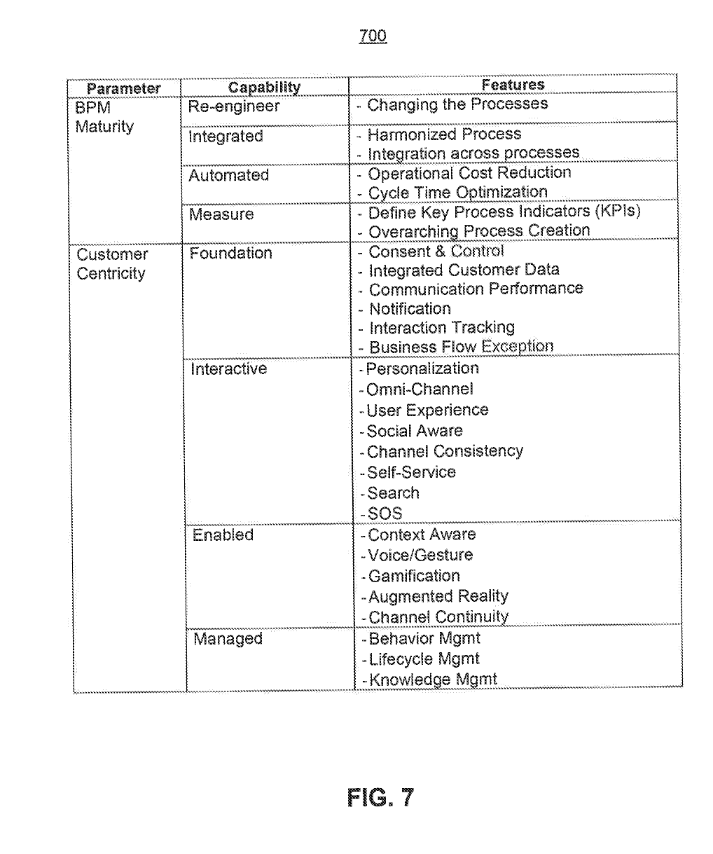

FIG. 7 is a table of exemplary BPM maturity states and customer centricity categories, according to some embodiments of the present disclosure. Table 700 includes exemplary categories that may correspond to the state of a BPM initiative. For example, harmonizing processes may attempt to analyze customer interactions across various processes and create a distinct customer process which may harmonize interactions across the various processes. Further, under the “enabled” category, support for various user interaction mechanisms may be implemented, such as voice interaction, augmented reality, and context awareness.

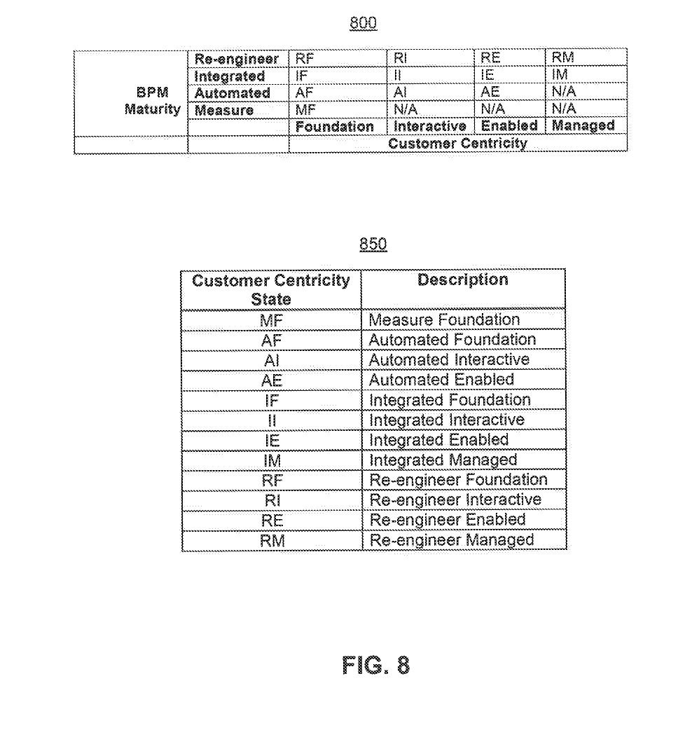

FIG. 8 illustrates an exemplary table relating BPM maturity states with customer centricity categories, according to some embodiments of the present disclosure. Table key 850 includes full titles for abbreviated customer centricity states user in table 800. Table 800 illustrates that different maturity states may not have the same objectives regarding different customer centricity categories. For example, when a BPM initiative is at the “measure” state, it may not be mature enough to warrant “enabled” customer centricity states. Similarly, when an application is in early development, implementing voice interaction may not be a key priority. The features of each customer centricity state from FIG. 8 may be determined by referencing the entries in FIG. 7.

As shown in FIG. 8, there may be 12 exemplary customer centricity states. However, in certain applications not all 12 exemplary customer centricity states may be necessary or used. Each state may have its own set of questions, which may be stored in assessment module 102. In an exemplary embodiment, the process owner may provide answers to the set of questions that corresponds to the customer centricity state at step 607.

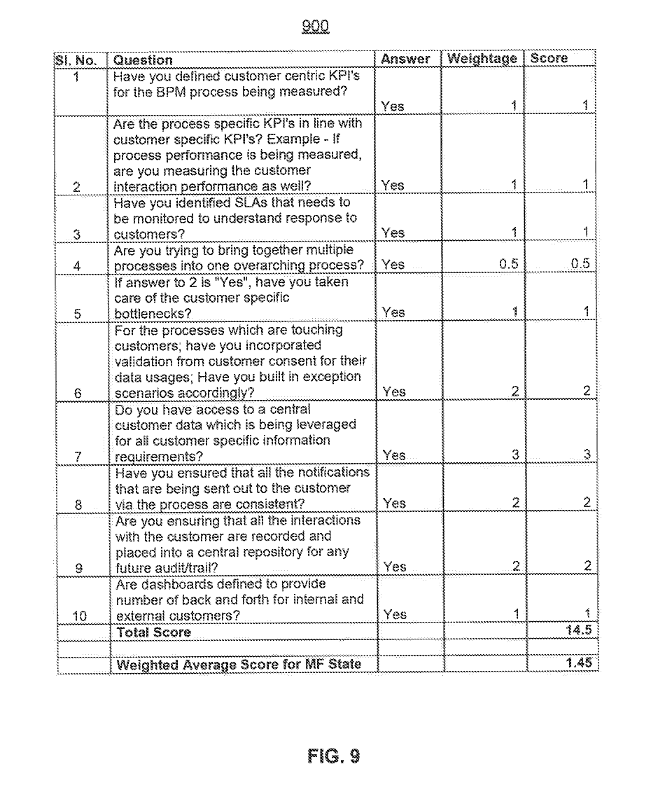

FIG. 9 is a table of exemplary questions and customer-centric BPM maturity scoring, according to an embodiment of the present disclosure. Table 900 includes exemplary questions that may be answered by a process owner as described above. The provided questions require yes-no answers, however additional question types may be presented with other types and amounts of responses. For each level of maturity there may be another detailed questioner.

Table 900 also includes exemplary scoring. Each question may have a particular weight, which may depend on a number of factors, such as its criticality to reaching the next maturity state or how important the feature is to the user. The weighted scores for each question may be summed to calculate a total score. Other calculations, such as a weighted average score or a percentage of the maximum score may be used depending on the preferences and needs of the users.

Once the customer centricity score has been determined, the score may be evaluated at step 608. This step may be achieved at assessment module 102. Based on the target score and the actual score achieved for the BPM initiative, an evaluation and comparison with other processes is presented. Based on these results, at step 609, detailed guidelines may be generated, describing how to reach the target score based on the present score. Guidelines may be generated and sorted based on the weightage points of certain criteria. For example, guidelines for achieving high-weightage questions may be presented first so that a process owner may make optimal improvements.

Next, at step 610, a report may be generated using reporting and analytics module 103. The report may include the entire questions and answers, along with a comparative score. The report may be available for print or digital download in a known file format.

At step 615, data may be resubmitted based on changes over time. For example, organizational goals may have been modified in administrative module 101. Additional exemplary resubmission circumstances may include the process undergoing substantial changes which affect how customer interaction takes place or a process owner wanting to reevaluate a process after successfully completing certain milestones.

For resubmission to take place, a user may repeat step 604 by completing login. Subsequently, at step 605, the BPM initiative may be determined to not be new because it is a resubmission. At step 611, a new customer centricity state is identified (see, e.g., the exemplary customer centricity states in FIG. 8). The new state may be based on the previous state and the improvement achieved. This may be accomplished by having a user answer a subset of the questions presented in step 606 to determine the initial state.

At step 612, the customer centricity score may be determined, similar to in step 607. However, at step 613, the new customer centricity score and new state may be compared with the previous score and previous state in conjunction with the organizational goals and all the evaluated processes using assessment module 102. A history of scores depicting their progression over time may be presented. Additionally, a percentage increase based on time may be calculated to determine process owner efficiency and effectiveness.

At step 614, guidelines may be updated depending upon changes in organizational goals and the customer centricity state of the BPM initiative at hand. In other embodiments, the guidelines may be static for the duration of the evaluation process. In such cases, step 614 may not be performed or the same guidelines generated in step 609 may be presented. After step 614 is completed, steps 610 and 615 may be repeated as described above.

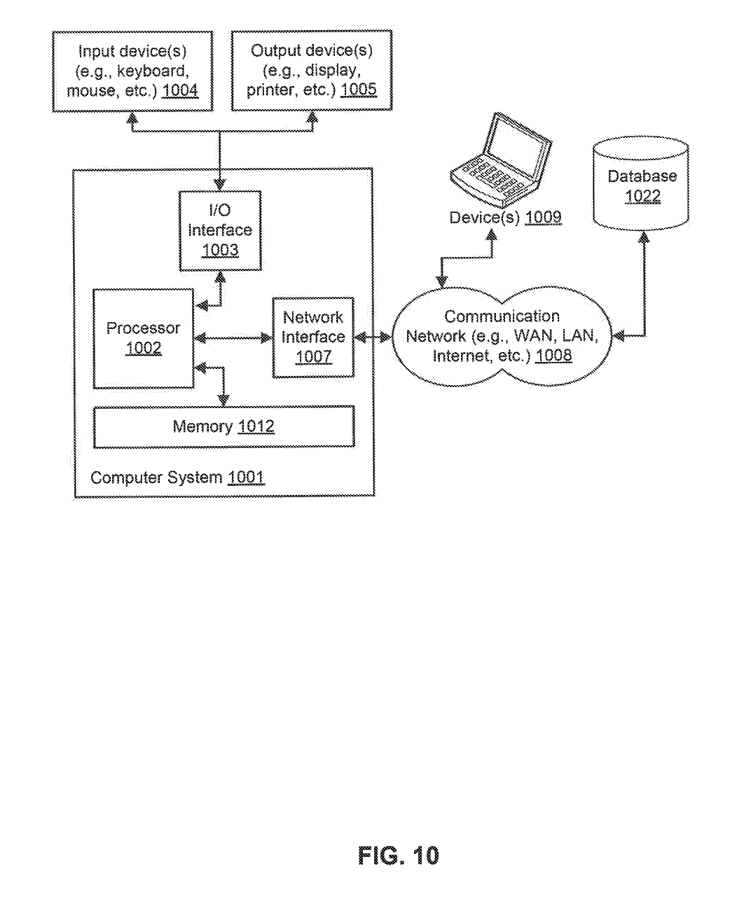

FIG. 10 illustrates an exemplary computer system 1001 for implementing methods and systems consistent with the present disclosure. For example, computer system 1001 may be used to perform the processes as described in FIG. 6. Further, computer system 1001 may be used to perform the function of the modules discussed above.

Computer system 1001 includes processor 1002, which may be a general purpose processor, such as various known commercial CPUs. Processor 1002 may interact with input device(s) 1004 and output device(s) 1005 via I/O interface 1003. A user or administrator may interact with computer system 1001 using input device(s) 1004 such as a keyboard, mouse, or card reader. Output device(s) 1005, such as a display or printer, may be used to display or print data reports produced from various process steps. Processor 1002 may also interact with memory 1012 to perform part or all of the disclosed method steps. Memory 1012 may be volatile or non-volatile memory capable of storing instructions, as well as any data necessary to facilitate the disclosed method steps. For example, memory 1012 may encompass RAM, ROM, or a solid-state drive.

Processor 1002 may also interact with communication network 1008 via network interface 1007 to contact remote device(s) 1009. Computer system 1001 may further communicate with database 1022 to gather remote or share data to perform any or all of the disclosed method steps. For example, database 1022 may store the question sets used for each customer centricity maturity state. Additionally, database 1022 may store administrative data, such as usernames and profiles. Database 1022 may be any networked storage, such as a networked RAID array or solid state drives operably connected to a network. Other networked storage arrangements are known in the art and could be used in a similar manner.

The specification has described systems and methods for assessing customer-centric BPM maturity of an organization. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A computer-implemented method for assessing customer centric BPM maturity of an organization, comprising:
creating, by at least one processor, an assessment model for an initiative, wherein creating the assessment model includes:
providing an initial assessment criteria selection for presentation on a user device,
receiving, from the user device, a selection of initial assessment criteria,
calculating a first score based on the selected assessment criteria,
determining a first maturity state of the initiative based on the first score, and
generating a first plurality of guidelines associated with the first score for moving the initiative to a maturity state that is not the first maturity state.

2. The method of claim 1, further comprising:
updating the assessment model by creating a new entry in the assessment model, wherein creating the new entry includes:
providing, for presentation on the user device, updated assessment criteria based on the first score;
receiving, from the user device, a selection of updated assessment criteria,
calculating an updated score based on the updated selected assessment criteria,
determining an updated maturity state of the initiative, and
generating an updated plurality of guidelines associated with the updated score for moving the initiative to a maturity state that is not the first maturity state or updated maturity state.

3. The method of claim 2, wherein the updated maturity state is based on at least one of the first maturity state and a difference between the first score and the updated score.

4. The method of claim 2, further comprising:
generating a report comparing at least the first score and the updated score, and the selected assessment criteria and the updated selected assessment criteria.

5. The method of claim 1, wherein receiving the selection of initial assessment criteria comprises receiving a plurality of binary answers, and wherein the first score is calculated based on the binary answers and a plurality of corresponding weights.

6. The method of claim 5, wherein the first plurality of guidelines describe how to reach a target score based on the plurality of binary answers and the plurality of corresponding weights.

7. The method of claim 1, further comprising:
updating the assessment model based on received threshold criteria.

8. The method of claim 1, further comprising:
determining that an assessment model does not exist for the initiative, and
creating the assessment model responsive to the determining.

9. A non-transitory, computer-readable medium storing instructions that, when executed by a processor, cause the processor to perform operations comprising:
creating an assessment model for an initiative, wherein creating the assessment model includes:
providing an initial assessment criteria selection for presentation on a user device,
receiving, from the user device, a selection of initial assessment criteria,
calculating a first score based on the selected assessment criteria,
determining a first maturity state of the initiative based on the first score, and
generating a first plurality of guidelines associated with the first score for moving the initiative to a maturity state that is not the first maturity state.

10. The computer-readable medium of claim 9, wherein the medium stores instructions that, when executed by the processor, perform further operations comprising:
updating the assessment model by creating a new entry in the assessment model, wherein creating the new entry includes:
providing, for presentation on the user device, updated assessment criteria based on the first score;
receiving, from the user device, a selection of updated assessment criteria,
calculating an updated score based on the updated selected assessment criteria,
determining an updated maturity state of the initiative, and
generating an updated plurality of guidelines associated with the updated score for moving the initiative to a maturity state that is not the first maturity state or updated maturity state.

11. The computer-readable medium of claim 10, wherein the updated maturity state is based on at least one of the first maturity state and a difference between the first score and the updated score.

12. The computer-readable medium of claim 9, wherein receiving the selection of initial assessment criteria comprises receiving a plurality of binary answers, and wherein the first score is calculated based on the binary answers and a plurality of corresponding weights.

13. A system for assessing customer centric BPM maturity of an organization, comprising:
one or more hardware processors; and
a memory storing instructions that, when executed by the one or more hardware processors, cause the one or more hardware processors to perform operations comprising:
creating an assessment model for an initiative, wherein creating the assessment model includes:
providing an initial assessment criteria selection for presentation on a user device,
receiving, from the user device, a selection of initial assessment criteria,
calculating a first score based on the selected assessment criteria,
determining a first maturity state of the initiative based on the first score, and
generating a first plurality of guidelines associated with the first score for moving the initiative to a maturity state that is not the first maturity state.

14. The system of claim 13, wherein the one or more hardware processors execute the instructions to perform operations further comprising:
updating the assessment model by creating a new entry in the assessment model, wherein creating the new entry includes:
providing, for presentation on the user device, updated assessment criteria based on the first score;
receiving, from the user device, a selection of updated assessment criteria,
calculating an updated score based on the updated selected assessment criteria,
determining an updated maturity state of the initiative, and
generating an updated plurality of guidelines associated with the updated score for moving the initiative to a maturity state that is not the first maturity state or updated maturity state.

15. The system of claim 14, wherein the updated maturity state is based on at least one of the first maturity state and a difference between the first score and the updated score.

16. The system of claim 14, wherein the one or more hardware processors execute the instructions to perform operations further comprising:
generating a report comparing at least the first score and the updated score, and the selected assessment criteria and the updated selected assessment criteria.

17. The system of claim 13, wherein receiving the selection of initial assessment criteria comprises receiving a plurality of binary answers, and wherein the first score is calculated based on the binary answers and a plurality of corresponding weights.

18. The system of claim 17, wherein the first plurality of guidelines describe how to reach a target score based on the plurality of binary answers and the plurality of corresponding weights.

19. The system of claim 13, wherein the one or more hardware processors execute the instructions to perform operations further comprising:
updating the assessment model based on received threshold criteria.

20. The system of claim 13, wherein the one or more hardware processors execute the instructions to perform operations further comprising:
determining that an assessment model does not exist for the initiative, and
creating the assessment model responsive to the determining.
